(19) United States
(12) Patent Application Publication
(10) Pub. No.: US 2016/0014561 A1
(43) Pub. Date: Jan. 14, 2016

(54) GEOLOCATION MESSAGING SERVICES

(71) Applicant: ZappApp, LLC., Dover, DE (US)

(72) Inventors: Gerald Thomas INZER, Washington, DC (US); Michael A. NARDELLI, Washington, DC (US); Brian Keith ROSS, Clarksville, MD (US); Richard Fintan GALWAY, Arnold, MD (US)

(21) Appl. No.: 14/796,750

(22) Filed: Jul. 10, 2015

Related U.S. Application Data
(60) Provisional application No. 62/023,041, filed on Jul. 10, 2014.

(51) Int. Cl. H04W 4/02; H04W 4/12; H04W 12/06

(52) U.S. Cl. CPC H04W 4/021; H04W 12/06; H04W 4/028; H04W 4/12

(57) ABSTRACT

Exemplary embodiments described herein provide methods, mediums, and systems related to location messages that may be exchanged between users of mobile devices. The location messages may allow the location of a first user to be displayed on the device of the second user. In some embodiments, a requesting user may send a request message requesting the location of another user. Furthermore, some embodiments may employ a concept of a “favorite,” which represents a combination of a location and one or more recipients. Using favoriting, the user may more quickly and efficiently send location messages to frequently-used contacts based on the context of the user's current location. In order to properly interpret messages sent from/to different types of devices, an intermediate server may be provided. The intermediate server may reformat the messages and/or transmitted data so that the messages may be properly interpreted by the recipients.

This application claims priority to and the benefit of provisional application No. 62/023,041 filed on Jul. 10, 2014, the entire disclosure of which is incorporated by reference herein.

### BACKGROUND

1. Technical Field

Example embodiments of the present application relate in general to geolocation messaging and more specifically to a method, a readable storage medium, and a system for exchanging geolocation messages between users of one or more mobile devices.

2. Related Art

Location-enabled devices allow a user's location to be determined relatively accurately. The location may be displayed, for example, on a map associated with the device. Such a capability may allow the user to determine their proximity to other locations or services within a geographical area.

However, if a first user wishes to inform a second user of the first user's current location, the first user's options may be limited. For example, the first user could send the second user a message indicating that they are near a particular geographical feature. Unfortunately, this process may be slow and error-prone, especially when multiple locations may fit the user's description (e.g., “I'm at the coffee shop on Main Street”).

Currently, there is a lack of services that allow a user to quickly, securely, and easily send their location to another user in a manner that can be easily interpreted by the other user.

### SUMMARY

The present application discusses methods, mediums, and systems for providing geolocation messages. The method, medium, and system for providing geolocation messages may include registering the one or more user devices with an intermediate service or with an intermediate server. The one or more user devices may be a mobile device, a telecommunication device, or a hardware device. The location information of one of the devices is determined by means of a global positioning system or a location based service. Geolocation messages, comprising the location information and additional information, may be exchanged between users of mobile devices to allow the location of a first user to be displayed on the device of the second user. The geolocation message of a first device transmits the location information of the first device to an intermediate service or an intermediate server. The intermediate service/server receives the location information and interprets the received location information based on the device type of the first device. The intermediate service/server formats the interpreted location information based the device type of a second device and transmits the location information of the first device to the second device. The received geolocation messages may be interpreted by a mapping function to allow the location of the first user to be displayed on a map on the second user's device.

In some embodiments, a location and one or more recipients may be combined into a “favorite.” The location may be, for example, a location from which the user frequently transmits or receives location messages, and the recipient(s) may be one or more selected contacts (e.g., contacts that the user frequently sends location messages to from the favorite location). Using favoriting, the user may more quickly and efficiently send location messages to frequently-used contacts based on the context of the user's current location.

Furthermore, a requesting user may send a request message requesting the location of another user. Upon receiving the location request, the other user may authorize the other user's device to send a location message including the other user's location to the requesting user's device.

An intermediate server may receive the location messages and/or the request messages and forward them to their respective destinations. The intermediate server may perform actions such as reformatting the messages and/or transmitted data so that the messages may be properly interpreted by the recipients. In this manner, users using different types of location-enabled devices may transmit location information to each other.

Although exemplary embodiments may be described herein with reference to particular software implementations, it is understood that the present invention is not limited to the embodiments disclosed herein.

### BRIEF DESCRIPTION OF THE DRAWINGS

FIG. 1 is a flowchart describing an exemplary procedure for sending a location message.

FIGS. 2A-2E depict exemplary interfaces suitable for use in the procedure of FIG. 1.

FIG. 3 is a flowchart describing an exemplary procedure for receiving a location message.

FIGS. 4A-4E depict exemplary interfaces suitable for use in the procedure of FIG. 3.

FIG. 5 is a flowchart describing an exemplary procedure for requesting a location message.

FIGS. 6A-6C depict exemplary interfaces suitable for use in the procedure of FIG. 5.

FIG. 7A is a flowchart describing an exemplary procedure for using “favorites.”

FIG. 7B depicts an exemplary interface suitable for use in the procedure of FIG. 7A.

FIG. 8 depicts an example computing device suitable for use with example embodiments described herein.

FIG. 9 depicts an example network implementation suitable for use with example embodiments described herein.

### DETAILED DESCRIPTION

Exemplary embodiments described herein relate to location messages that may be exchanged between users of mobile devices to allow the location of a first user to be displayed on the device of the second user. In some embodiments, a requesting user may send a request message requesting the location of another user. Upon receiving the location request, the other user may authorize the other user's device to send a location message including the other user's location to the requesting user's device.

Some embodiments may employ a concept of a “favorite,” which represents a combination of a location and one or more recipients. Using favoriting, the user may more quickly and efficiently send location messages to frequently-used contacts based on the context of the user's current location.

In order to properly interpret messages sent from/to different types of devices (potentially employing different protocols and/or using different types of software), an intermediate server may be provided. The intermediate server may reformat the messages and/or transmitted data so that the messages may be properly interpreted by the recipients.

These and other features of the present invention will be described in detail below.

### Sending a Location Message

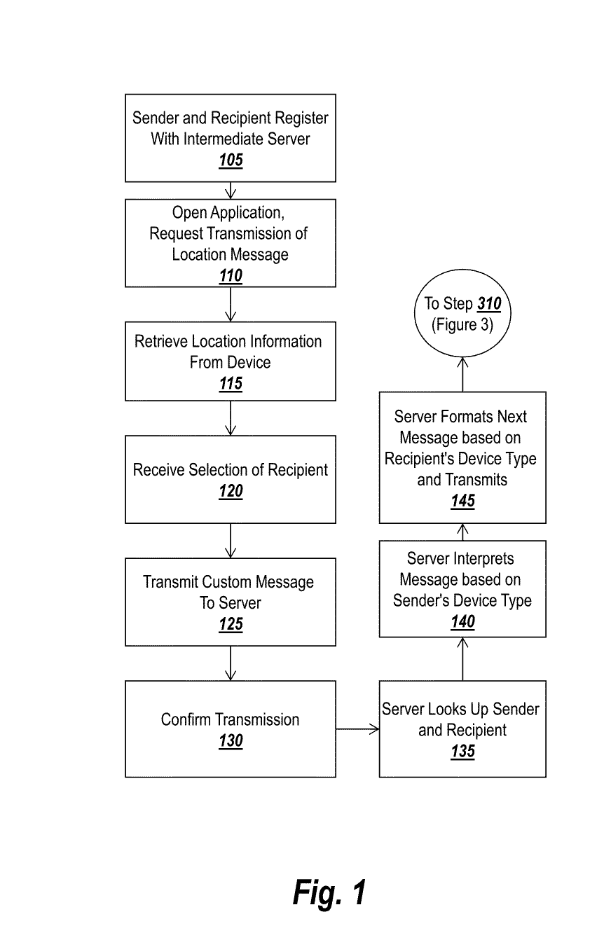

FIG. 1 is a flowchart depicting an exemplary procedure for sending a location message according to one embodiment. The procedure may begin at step 105, where users may register with an intermediate location server. The intermediate location server may act as a go-between and may serve several different functions, such as maintaining security through authentication and encryption, and allowing for communication between different types of devices. The intermediate server may be implemented as any suitable type of electronic device, and may be connected to a device of a sender and a device of a recipient via a network, such as the internet. To this end, the intermediate server may include a non-transitory storage medium for storing one or more databases (e.g., a database of users and/or a database of location messages), a processor for interpreting and translating messages, and a transmitter/receiver for sending and receiving messages over the network.

At step 105, the intermediate server may receive a registration request from a user. The registration request may include an identifier of the user, such as a name or login ID, a type of location-enabled device of the user (e.g., a type of mobile phone, tablet, or laptop), and a phone number of the user.

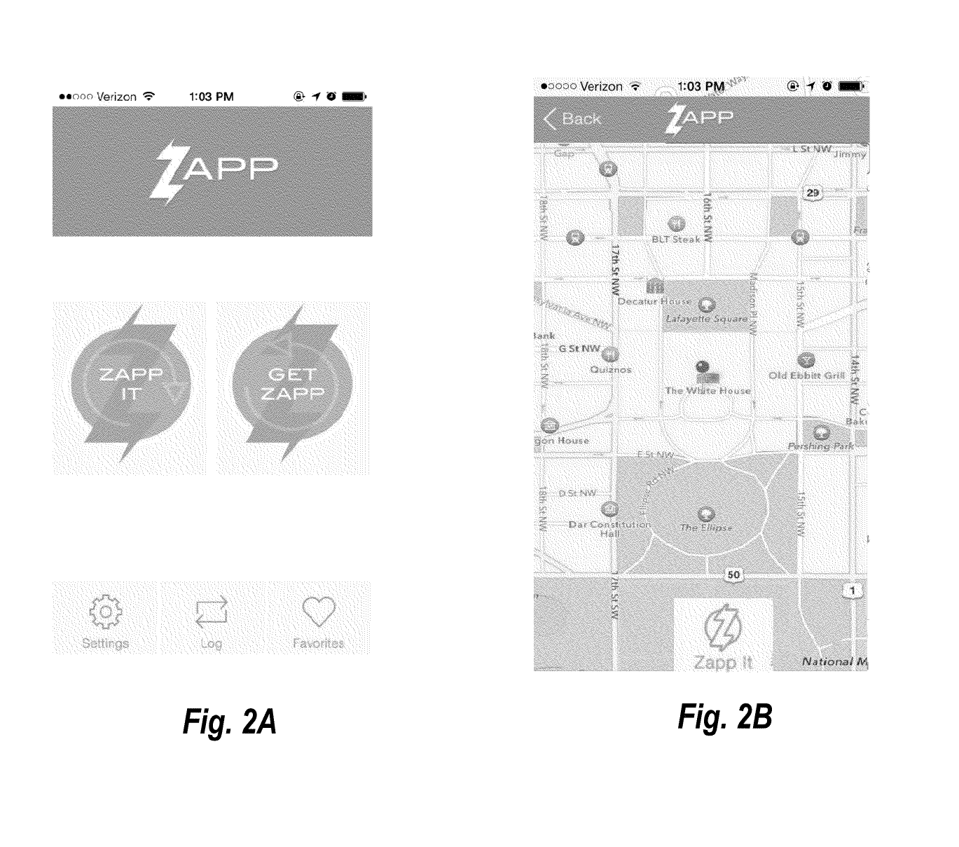

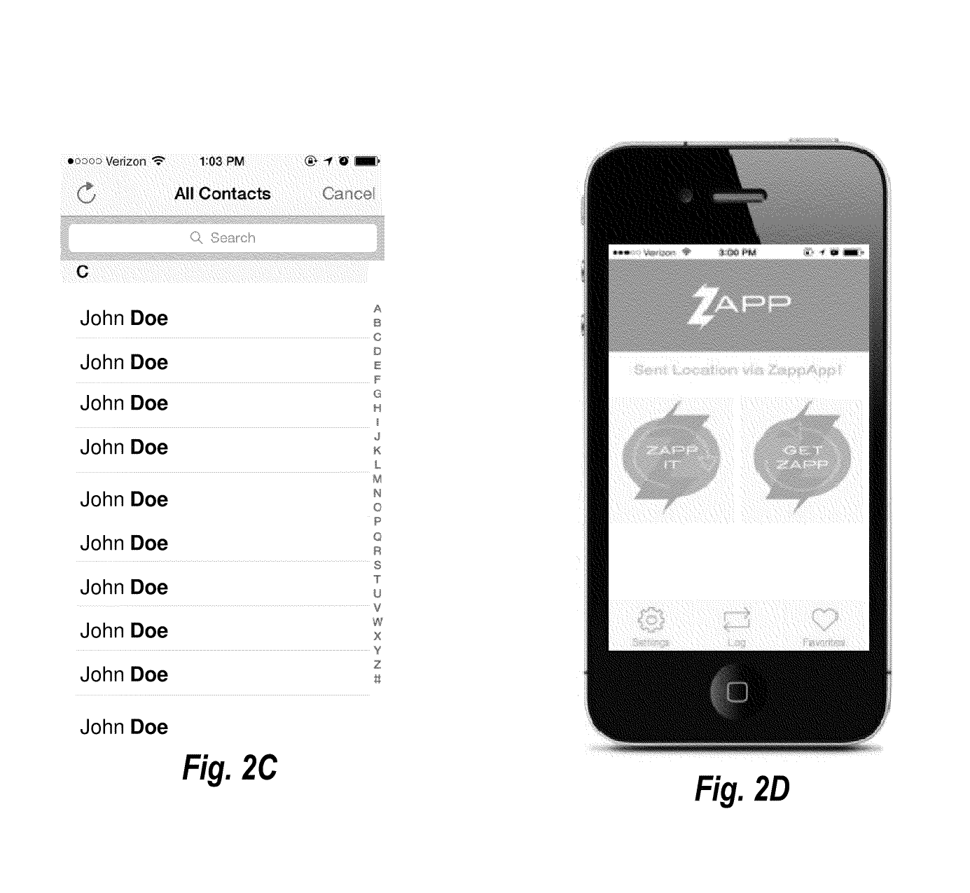

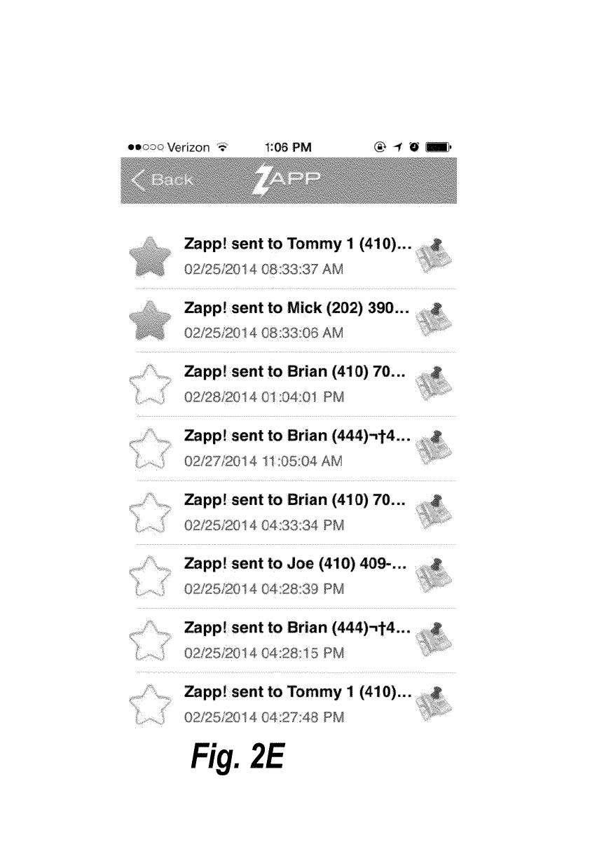

At step 110, a first user may optionally open an application on their location-enabled device and request the transmission of a location message. An exemplary interface for an application for requesting the transmission of a location message is depicted in FIG. 2A. In the exemplary “Zapp” application depicted in FIGS. 2A-2E, a location message is referred to as a “Zapp” and requesting the transmission of a location message is referred to as “Zapping.” In FIG. 2A, a user may select the “Zapp It” selection in the interface in order to request that a location message be transmitted.

Optionally, the first user may specify, at step 110, one or more keywords or tags to be appended to the message. For example, a user sending their location to another user in the hopes of meeting the other user for coffee might append a “coffee” tag to the message. Other examples of tags might include “food,” “movie,” “baseball game,” and numerous other possibilities.

In some embodiments, keywords or tags may be automatically derived based on the context in which the user transmits the message. For example, if the user is located in a restaurant at lunchtime, the location application may automatically append the keyword “food” to the message. The context may be determined, for example, based on the user's location, the location of nearby services, the time of day, previous location message history (e.g., if the user has previously appended tags at a similar location or at a similar time or when transmitting location messages to similar recipients).

Alternatively or in addition, the user may specify a message to be transmitted with the location message. Each location message may be tagged with a message ID.

At step 115, the first user's location-enabled device may retrieve location information. For example, the first user's location-enabled device may be equipped with a global positioning system receiver and/or other location-based services that allow the device to determine the device's location. The retrieved location may optionally be displayed to the first user.

FIG. 2B depicts an exemplary interface suitable for displaying the sender's location. It is noted that the sender may or may not be provided with an interface like the one in FIG. 2B. In some embodiments, the sender's location-enabled device may retrieve the user's location without displaying a map to the sender. In other embodiments, a map may be displayed so that the user can confirm that the correct location information is being transmitted. The display of the location information may also allow the sender to visualize how the recipient will see the user's location, since the recipient may be presented with the same or a similar interface to the one in FIG. 2B upon receipt of the location message. In some embodiments, the sender may use the interface to adjust the location transmitted to the user (e.g., by dragging the selected location to a different location).

At step 120, a selection of one or more recipients may be received by the first user's location-enabled device. In one embodiment, the first user may enter user IDs for the selected recipients into a recipient field in the location application. In another embodiment, the first user may select recipients from a list. FIG. 2C depicts an exemplary interface for allowing the sender to select one or more recipients of the location message. In the example depicted in FIG. 2C, the location application accesses the sender's location-enabled device's contact list. Such an embodiment may be particularly suited to location-enabled devices such as mobile phones or tablets. The sender may select one or more of the contacts in the interface to designate intended recipients for the location message.

Upon receipt of the intended recipients, at step 125 the first user's location-enabled device may transmit the location message to the intermediate server. The message may identify, for example, the location of the first user (e.g., using latitude and longitude, or any other suitable means of identifying a location), an identifier identifying the first user (the “sender”), an identifier identifying the intended recipient(s) (e.g., the recipient's phone number or location application ID), and a message from the first user and/or any tags or keywords identified at step 110.

The device may transmit the message according to a custom format. One example of a custom format is shown below:

ServerName/PageName?m=send&lat=[lat]&long=[long]&d=[sender
device id]&sendto=[recip phone #]&msg=[message/zapptags]

At step 130, the first user's location-enabled device may confirm that the location message has been successfully sent. For example, upon receiving an acknowledgement from the server, the location application may display a notification or message indicating that the message has been sent.

FIG. 2D depicts an exemplary interface for confirming to the sender that the location message has been successfully sent. A field, frame, or window (such as the frame in the upper portion of the interface of FIG. 2D) may include a confirmation message indicating that the message was sent.

FIG. 2E depicts another example of a confirmation interface in the form of a history list. The history list may include a list of recent location messages sent, who the messages were sent to and at what time, and an option for viewing the location that was transmitted. Furthermore, the interface may include a selection (in the form of a togglable star in FIG. 2E) that allows for a location/recipient pairing to be selected as a “favorite” (discussed in more detail below).

At step 135, the intermediate server may receive the location message and parse the location message to identify the sender and recipient. The intermediate server may look up the sender and/or recipient in the server's user database and retrieve a device type associated with the sender and a device type associated with the recipient. Different device types may format location messages differently, and by retrieving the device type of the sender and/or recipient, the server may be capable of interpreting the received location message and/or formatting an outgoing location message destined for the recipient in a manner that will be understandable by the recipient's device.

Accordingly, at step 140, the intermediate server may use the sender information obtained at step 135 to interpret the sender's location message. Optionally, the intermediate server may log the location message of the sender in a database. If the user supplied any keywords when transmitting the location message, or if any keywords were derived from the user's context, the keywords may also be logged in the database.

At step 145, the server use the information retrieved at step 135 to format an outgoing message including the location information from the sender's message in a format that is understandable by the recipient's device. The server may transmit the outgoing message to the recipient.

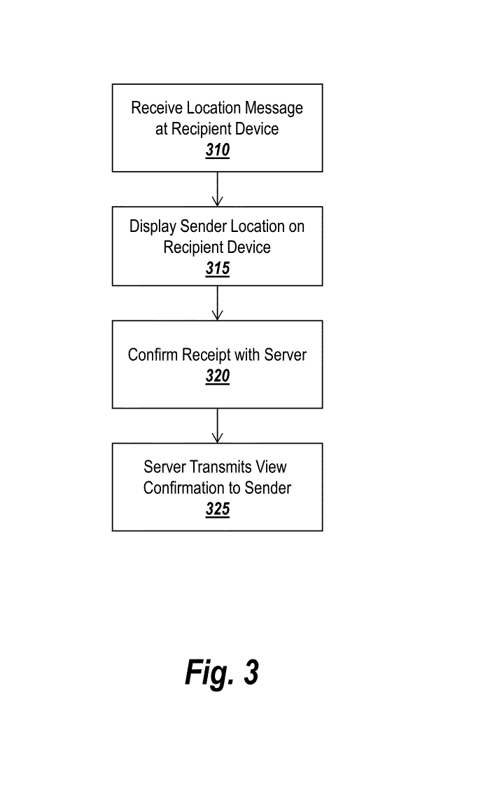

Next, processing may proceed to step 310 (see FIG. 3), where the location message may be received and interpreted by the recipient's location-enabled device.

### Receiving a Location Message

FIG. 3 depicts a flowchart that describes a procedure for receiving a location message at a recipient's location-enabled device.

At step 310, the location message may be received by a receiver of the recipient device. The recipient device may include one or more event handlers that direct a message formatted as a location message to an application of the recipient device (such as the above-noted “Zapp” application). Upon receiving the message and recognizing the message as a location message, the recipient's device may cause a notification to be displayed.

Example code for displaying a notification on an Apple iOS-based device is shown below:

```
“aps”: {
    “alert”: “Zapp from Your Name”
    “badge”: 1,
    “sound”: “Zappsound.aiff”
},
      “z”: “[send location/request location]”,
      “to”: “[phone num of recip]”,
      “fr”: “[phone num of sender]”,
      “lat”: “[latitute of location]”,
      “lon”: “[longitude of location]”
}
```

Example code for displaying a notification on a Google Android-based device is shown below:

```
{
      “message”: “Zapp from Your Name”,
      “badge”: 1,
      “sound”: “Zappsound.wav”
      “z”: “[send location/request location]”,
      “to”: “[phone num of recip]”,
      “fr”: “[phone num of sender]”,
      “lat”: “[latitute of location]”,
      “lon”: “[longitude of location]”
}
```

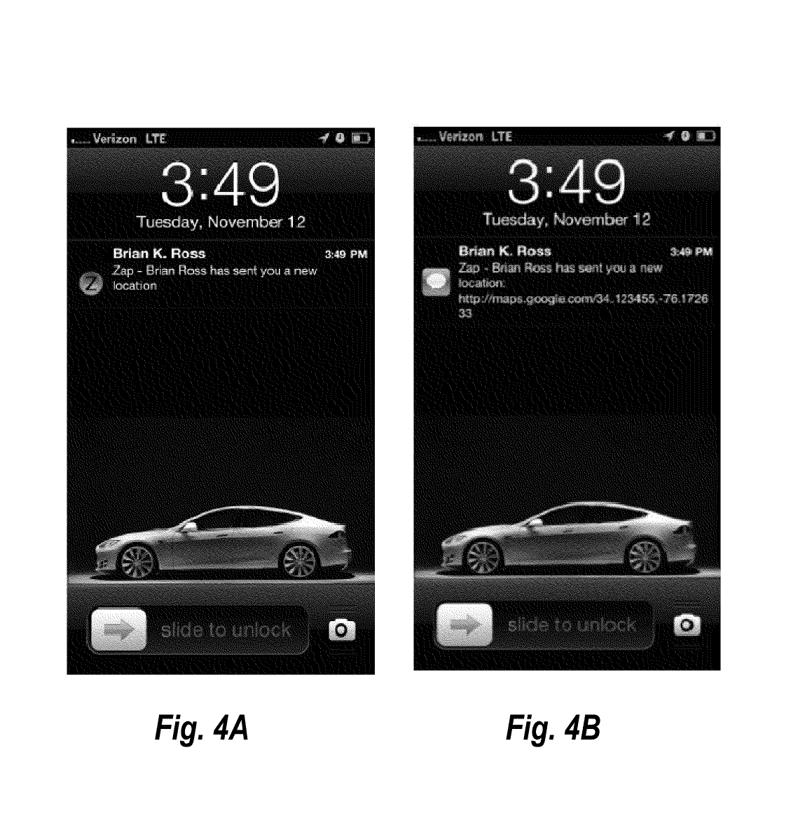

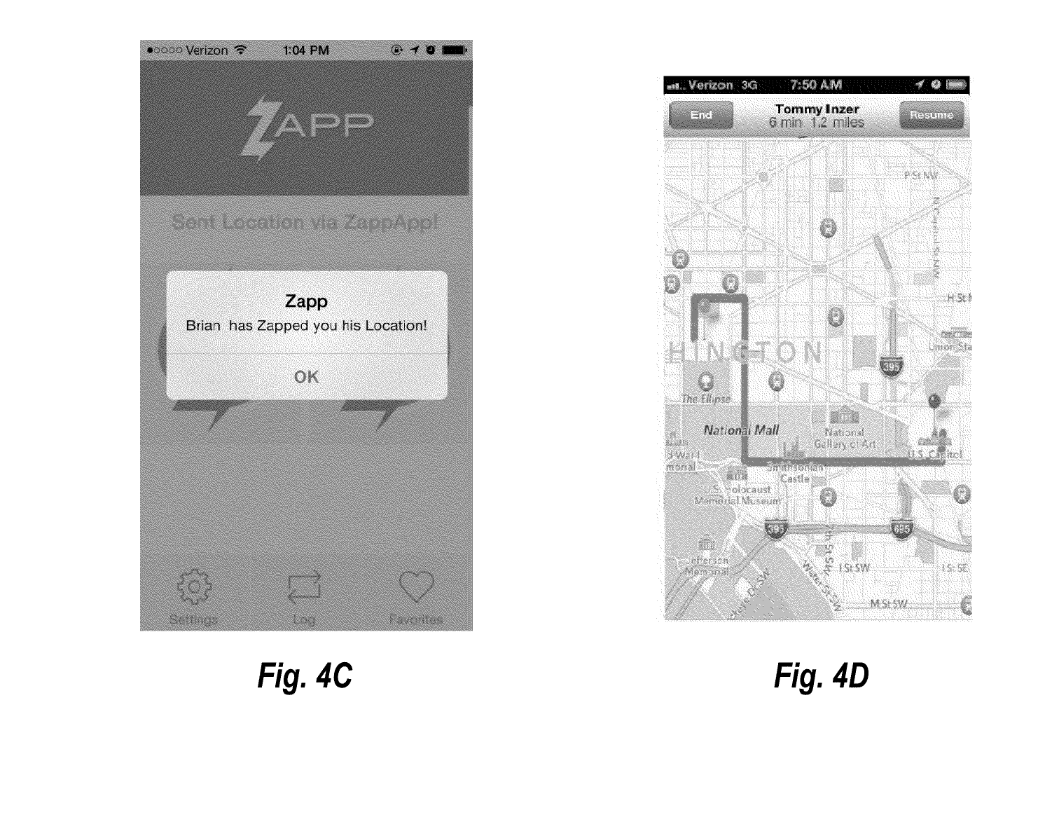

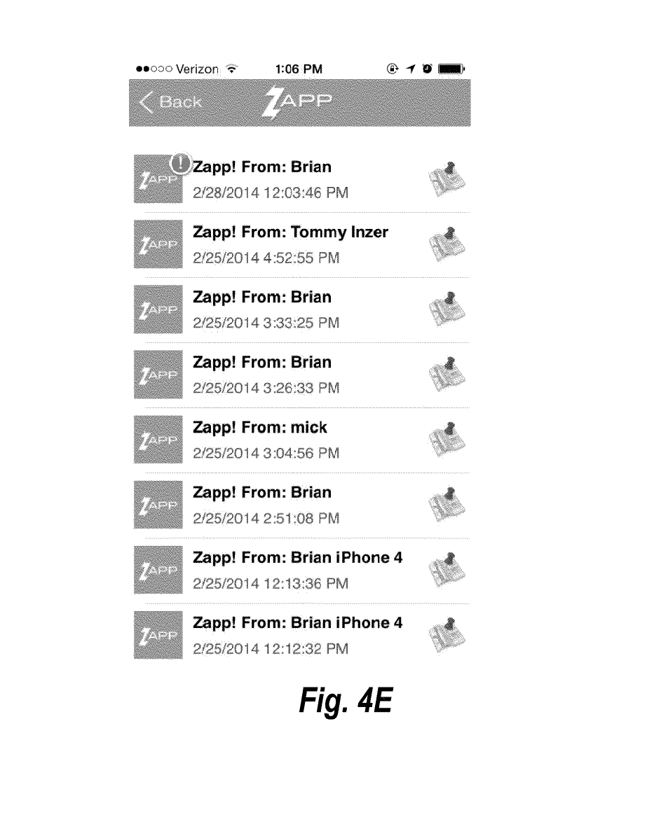

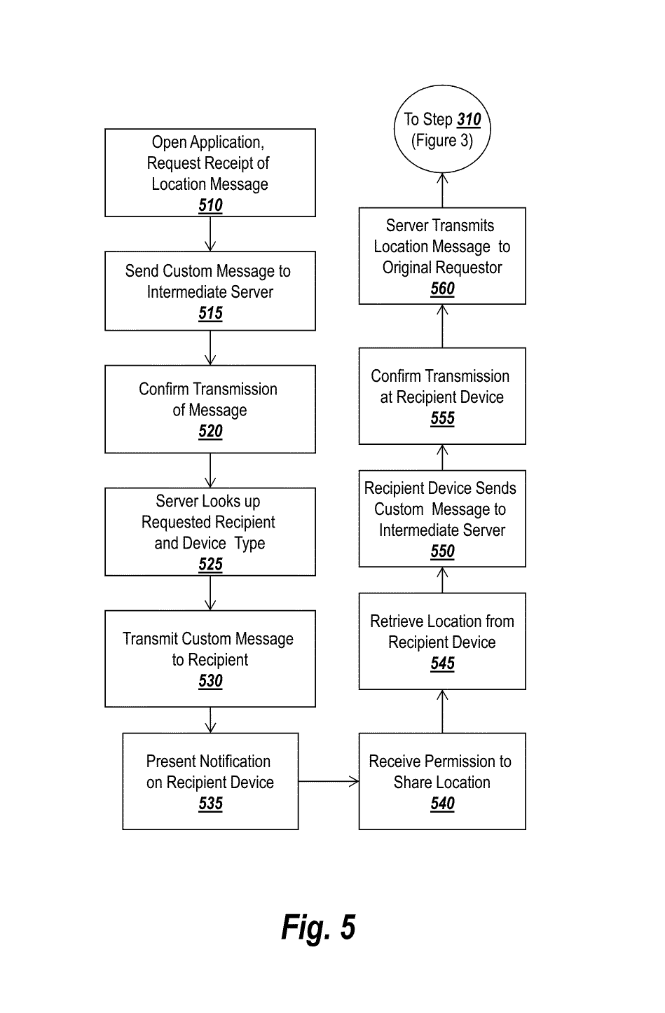

FIGS. 4A and 4B depict two examples of displaying notifications of a new location message. In the example of FIGS. 4A and 4C, the recipient's device may include a location application for handling the location message, and the notification may be formatted to conform to the application's requirements. Selecting the notification may take the recipient to the location application and display the sender's location within the location application (or another application, such as a mapping application).

However, it is not a requirement that the recipient have access to the same location application as the original sender (or any location application at all). For example, if the intermediate server determines that the recipient is not in the database of registered users, the intermediate server may nonetheless generate a generic message (e.g., an SMS message) including the location information and/or a link to a mapping service and forward the generic message to the recipient using the information (e.g., a recipient phone number) specified by the original sender. FIG. 4B depicts an example of a message received in SMS format.

At step 315, the sender's location may be retrieved from the location message and may be displayed on the recipient's device. For example, latitude and longitude coordinates may be extracted from the message and provided to a mapping program on the recipient's device. The mapping program may interpret the coordinates and display a location corresponding to the coordinates on a map.

Optionally, the recipient's device may also retrieve the current location of the recipient and display directions to the original sender, as shown in FIG. 4D.

In some embodiments, the intermediate server and/or software running on the recipient's device may cross-reference the location from the location message (and/or any keywords in the message) with a list of advertisers. For example, the recipient may be shown business suggestions that are near the zapped location based on one or more keywords in the message. In one example, if a sender zapped their location with a message that said “Meet for lunch?”, then the recipient may be provided with a list of restaurants near the zapped location.

Received location messages may be stored in a history list on the recipient's device, as shown for example in FIG. 4E.

At step 320, the recipient's device may generate a read receipt and transmit the read receipt back to the intermediate server. This may confirm to the server that the location message has been viewed. The read receipt may be in a custom format. An example of such a custom format is depicted below:

m=view&i=[message id] &d=[sender device id]

At step 325, the server may receive the read receipt from the recipient, format an outgoing read receipt message in a manner that is compatible with the original sender's device type, and forward the read receipt to the original sender. The original sender may receive a notification that the location message has been viewed.

### Requesting a Location Message

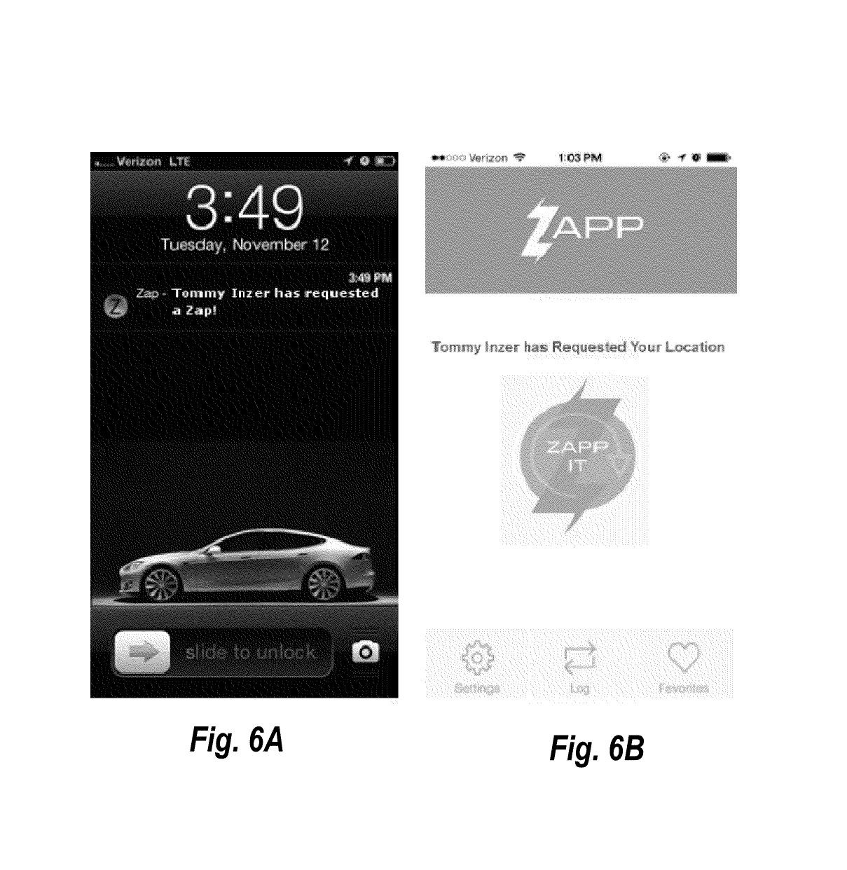

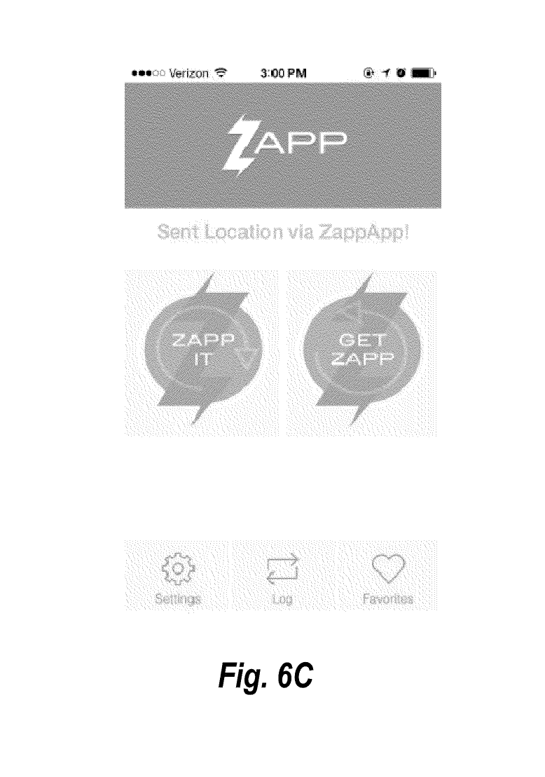

The above-described embodiments relate to a situation in which a first user decides to send their location to a second user. However, in some situations it may be desirable to be able to request a location from another user. Accordingly, in some embodiments, options may be provided for a user to request that another user provide their location. One such embodiment is described below with respect to FIGS. 5 and 6A-6C.

At step 510, a requesting user may open a location application and request the location of another user. For example, in the interface previously depicted in FIG. 2A, the user could select the “Get Zapp” option in order to request the location of another user.

At step 515, in response to the request, the requesting user's device may transmit a message to the intermediate server. The message may be formatted in a custom format, such as the example formats depicted below:

ServerName/PageName?m=view&i=[zapp id]&d=[sender device id]
m=req&d=[sender device id]&sendto=[recip phone #]

At step 520, the requesting user's device may display a confirmation that the message has been transmitted. This step may generally correspond to step 130 from FIG. 1.

At step 525, the server may look up the device types of the sender and the recipient, and may format a request message in a manner compatible with the intended recipient's device type. This step may generally correspond to steps 135-145 from FIG. 1.

At step 530, the server may transmit a custom request message to the intended recipient of the request. The custom request message may be similar to the messages described above at step 515.

At step 535, the recipient's device may receive the request and may display a notification of the request. FIGS. 6A-6B depict exemplary interfaces for displaying a notification of the request. The notifications may be displayed in a manner similar to that already described above with respect to step 310 of FIG. 3.

At step 540, the recipient may provide permission to share their location information. For example, the recipient may be provided with an interface to accept or decline the request. If the request is declined, then optionally a decline message may be transmitted back to the original requestor to inform the requestor that their location request has been declined.

If the recipient provides permission to share their location at step 540, then processing may proceed to steps 545-560. These steps may generally correspond to steps 115-145 from FIG. 1. Upon completing the transmission of the message, a confirmation notification may be displayed, such as the one depicted in FIG. 6C.

Finally, processing may proceed to step 310 (see FIG. 3), where the location message may be received and interpreted by the original requestor's location-enabled device.

### Favoriting

According to exemplary embodiments, a simplified procedure for sending location information is provided in the form of “favoriting.” As used herein, a “favorite” refers to a combination of a location with one or more intended recipients, which may be used to quickly and efficiently transmit location information (e.g., using a single action). The location/recipient pairings may be pre-defined and pre-stored, or may be selected based on context (e.g., frequently-messaged users that are often contacted from the sender's current location).

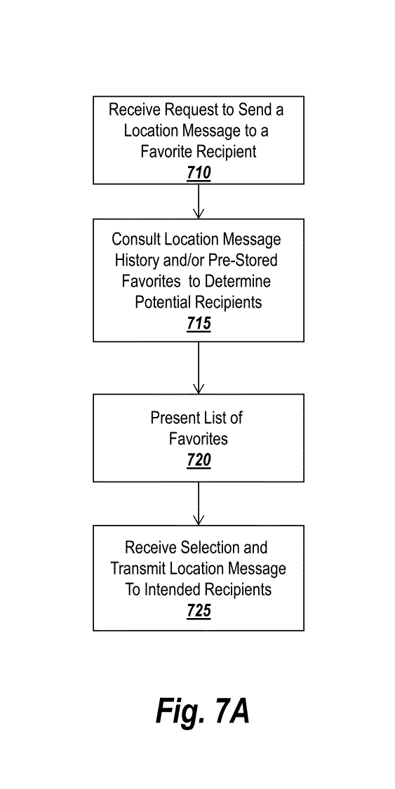

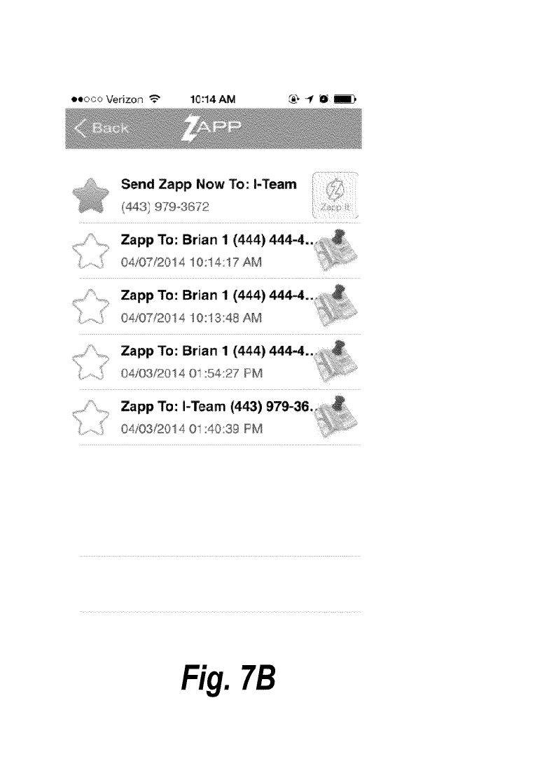

FIG. 7A depicts an exemplary procedure for transmitting location messages to recipient's on a sender's favorites list. The application maintains a history of locations and users to which messages have been sent. When it is desired to send a location message to a recipient that has already received a message in the past, or when it is desired to resend a location to a different recipient, the user only has to press the “favorite” icon next to that user's name, and the application will automatically send the users current location.

At step 710, the user has decided to send a message to a “Favorite,” and submits a request to the application. For example, in the interface depicted in FIG. 2A, the user may select the “favorites” icon in the lower-left corner of the interface.

At step 715, the location application may consult the above-described message history and/or any pre-stored favorites to determine a context-dependent list of potential recipients. Potential recipients may include recipients that are often (or have previously been) contacted at the current location, at the current time of day, or groups of contacts specified by the user, among other possibilities. The potential recipients may also include recipients who have previously requested the user's location in the current context (e.g., at the current time or location).

At step 720, the list generated at step 720 may be displayed on an interface. FIG. 7B depicts an exemplary interface suitable for displaying potential recipients.

At step 725, the user may select one or more of the favorites to transmit their location to the selected recipients. The selected recipients may be stored, along with the user's current location, as a favorite pair for future use.

Advantageously, this procedure allows potential recipients to be selected in a single action without the need to manually search for the recipients (e.g., in a contacts list).

### Computer-Implemented Embodiments

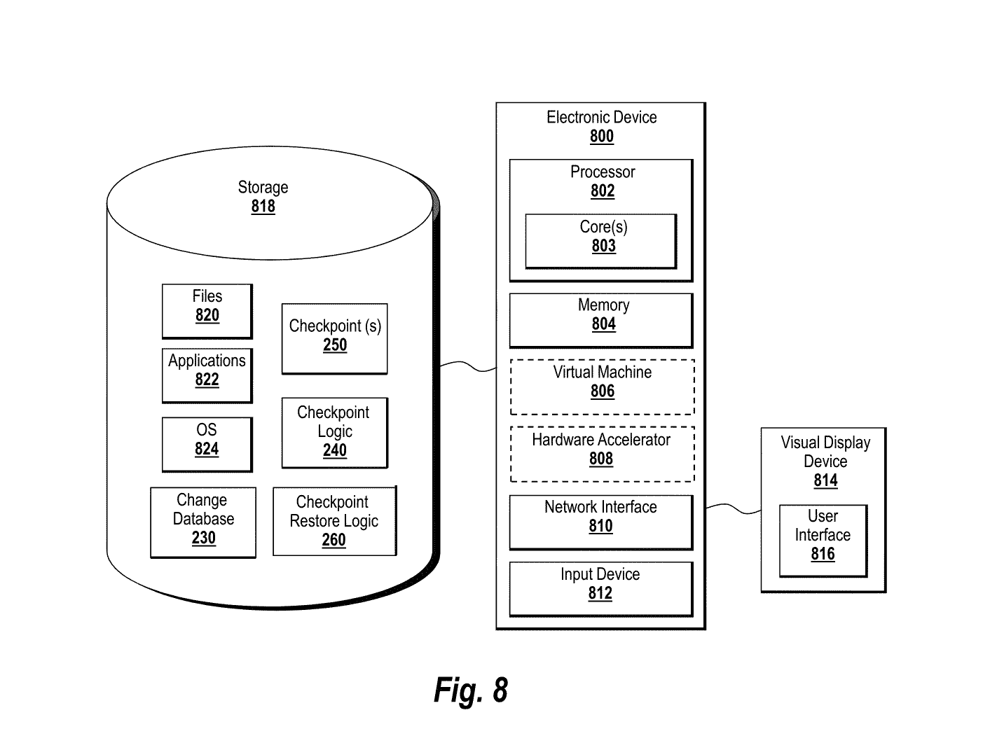

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 8 depicts an example of an electronic device 800 suitable for use with one or more embodiments described herein.

The electronic device 800 may take many forms, including but not limited to a computer, workstation, server, network computer, quantum computer, optical computer, Internet appliance, mobile device, a pager, a tablet computer, a smart sensor, application specific processing device, etc.

The electronic device 800 is illustrative and may take other forms. For example, an alternative implementation of the electronic device 800 may have fewer components, more components, or components that are in a configuration that differs from the configuration of FIG. 8. The components of FIG. 8 and/or other figures described herein may be implemented using hardware based logic, software based logic and/or logic that is a combination of hardware and software based logic (e.g., hybrid logic); therefore, components illustrated in FIG. 6 and/or other figures are not limited to a specific type of logic.

The processor 802 may include hardware based logic or a combination of hardware based logic and software to execute instructions on behalf of the electronic device 800. The processor 802 may include logic that may interpret, execute, and/or otherwise process information contained in, for example, the memory 804. The information may include computer-executable instructions and/or data that may implement one or more embodiments of the invention. The processor 802 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 803. Moreover, the processor 802 may include a system-on-chip (SoC) or system-in-package (SiP). An example of a processor 802 is the Intel® Core™ series of processors available from Intel Corporation, Santa Clara, Calif.

The electronic device 800 may include one or more tangible non-transitory computer-readable storage media for storing one or more computer-executable instructions or software that may implement one or more embodiments of the invention. The non-transitory computer-readable storage media may be, for example, the memory 804 or the storage 818. The memory 804 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 800 may include a virtual machine (VM) 804 for executing the instructions loaded in the memory 804. A virtual machine 806 may be provided to handle a process running on multiple processors so that the process may appear to be using only one computing resource rather than multiple computing resources. Virtualization may be employed in the electronic device 800 so that infrastructure and resources in the electronic device may be shared dynamically. Multiple VMs 806 may be resident on a single computing device 800.

A hardware accelerator 808 may be implemented in an ASIC, FPGA, or some other device. The hardware accelerator 808 may be used to reduce the general processing time of the electronic device 800.

The electronic device 800 may include a network interface 810 to interface to a Local Area Network (LAN), Wide Area Network (WAN) or the Internet through a variety of connections including, but not limited to, standard telephone lines, LAN or WAN links (e.g., T1, T3, 56kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 708 may include a built-in network adapter, network interface card, personal computer memory card international association (PCMCIA) network card, card bus network adapter, wireless network adapter, universal serial bus (USB) network adapter, modem or any other device suitable for interfacing the electronic device 800 to any type of network capable of communication and performing the operations described herein.

The electronic device 800 may include one or more input devices 812, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 800 may include other suitable I/O peripherals.

The input devices 812 may allow a user to provide input that is registered on a visual display device 814. A graphical user interface (GUI) 816 may be shown on the display device 814.

A storage device 818 may also be associated with the computer 800. The storage device 818 may be accessible to the processor 802 via an I/O bus. The information in the storage device 818 may be executed, interpreted, manipulated, and/or otherwise processed by the processor 802. The storage device 818 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 818 may store any modules, outputs, displays, files 820, information, user interfaces, etc, provided in example embodiments. The storage device 818 may store applications 822 for use by the computing device 800 or another electronic device. The applications 822 may include programs, modules, or software components that allow the computing device 1300 to perform tasks. Examples of applications include word processing software, shells, Internet browsers, productivity suites, and programming software. The storage device 818 may store additional applications for providing additional functionality, as well as data for use by the computing device 800 or another device. The data may include files, variables, parameters, images, text, and other forms of data.

The storage device 818 may further store an operating system (OS) 824 for running the computing device 800. Examples of OS 824 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the invention may be implemented in a programming language. Some examples of languages that may be used include, but are not limited to, Python, C, C++, C#, SystemC, Java, Javascript, a hardware description language (HDL), unified modeling language (UML), and Programmable Logic Controller (PLC) languages. Further, one or more embodiments of the invention may be implemented in a hardware description language or other language that may allow prescribing computation. One or more embodiments of the invention may be stored on or in one or more mediums as object code. Instructions that may implement one or more embodiments of the invention may be executed by one or more processors. Portions of the invention may be in instructions that execute on one or more hardware components other than a processor.

It is understood that the present invention may be implemented in a distributed or networked environment. For example, models may be provided and manipulated at a central server, while a user interacts with the models through a user terminal.

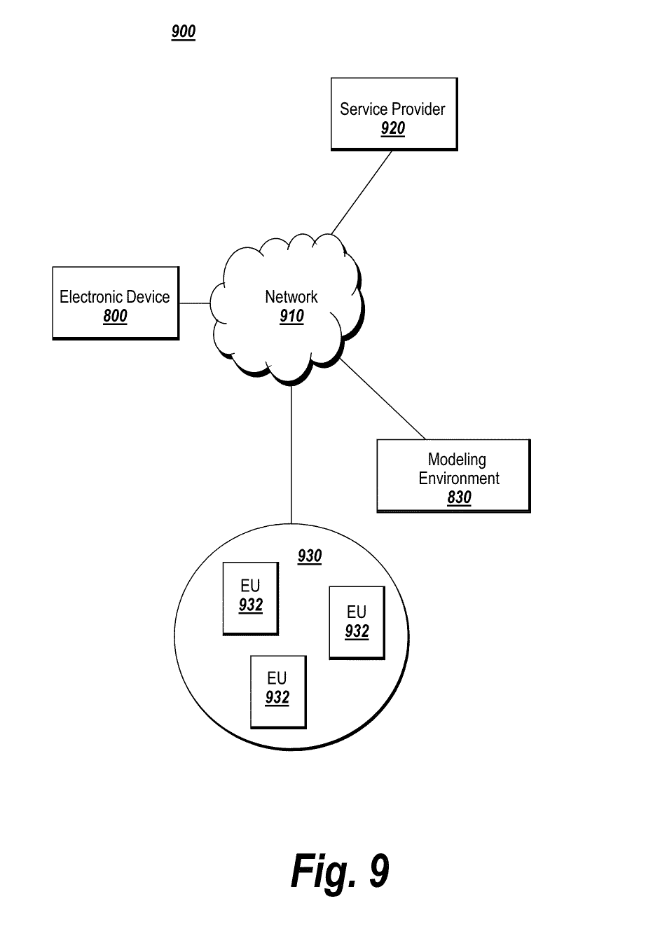

FIG. 9 depicts a network implementation that may implement one or more embodiments of the invention. A system 900 may include a computing device 800, a network 910, a service provider 920, a modeling environment 830, and a cluster 930. The embodiment of FIG. 9 is exemplary, and other embodiments can include more devices, fewer devices, or devices in arrangements that differ from the arrangement of FIG. 9.

The network 910 may transport data from a source to a destination. Embodiments of the network 910 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., the computing device 800, the service provider 920, etc.). Data may include digital information or analog information. Data may further be packetized and/or non-packetized.

The network 910 may be a hardwired network using wired conductors and/or optical fibers and/or may be a wireless network using free-space optical, radio frequency (RF), and/or acoustic transmission paths. In one implementation, the network 910 may be a substantially open public network, such as the Internet. In another implementation, the network 910 may be a more restricted network, such as a corporate virtual network. The network 910 may include Internet, intranet, Local Area Network (LAN), Wide Area Network (WAN), Metropolitan Area Network (MAN), wireless network (e.g., using IEEE 802.11), or other type of network The network 910 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

The service provider 920 may include a device that makes a service available to another device. For example, the service provider 920 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

The modeling environment 830 may include a device that receives information over the network 910. For example, the modeling environment 830 may be hosted on a device that receives user input from the electronic device 800.

The cluster 930 may include a number of Execution Units (EU) 932, and may perform processing on behalf of the electronic device 800 and/or another device, such as the service provider 920. For example, the cluster 930 may perform parallel processing on an operation received from the electronic device 800. The cluster 930 may include EUs 932 that reside on a single device or chip or that reside on a number of devices or chips.

The EUs 930 may include processing devices that perform operations on behalf of a device, such as a requesting device. An EU may be a microprocessor, field programmable gate array (FPGA), and/or another type of processing device. The EU 932 may include code, such as code for an operating environment. For example, an EU may run a portion of an operating environment that pertains to parallel processing activities. The service provider 920 may operate the cluster 930 and may provide interactive optimization capabilities to the electronic device 800 on a subscription basis (e.g., via a web service).

EUs may provide remote/distributed processing capabilities for products such as the modeling environment 830 of FIG. 8. A hardware EU may include a device (e.g., a hardware resource) that may perform and/or participate in parallel programming activities. For example, a hardware EU may perform and/or participate in parallel programming activities in response to a request and/or a task it has received (e.g., received directly or via a proxy). A hardware EU may perform and/or participate in substantially any type of parallel programming (e.g., task, data, stream processing, etc.) using one or more devices. For example, a hardware EU may include a single processing device that includes multiple cores or a number of processors. A hardware EU may also be a programmable device, such as a field programmable gate array (FPGA), an application specific integrated circuit (ASIC), a digital signal processor (DSP), or other programmable device. Devices used in a hardware EU may be arranged in many different configurations (or topologies), such as a grid, ring, star, or other configuration. A hardware EU may support one or more threads (or processes) when performing processing operations.

A software EU may include a software resource (e.g., a technical computing environment) that may perform and/or participate in one or more parallel programming activities. A software EU may perform and/or participate in one or more parallel programming activities in response to a receipt of a program and/or one or more portions of the program. A software EU may perform and/or participate in different types of parallel programming using one or more hardware units of execution. A software EU may support one or more threads and/or processes when performing processing operations.

The term ‘parallel programming’ may be understood to include multiple types of parallel programming, e.g. task parallel programming, data parallel programming, and stream parallel programming. Parallel programming may include various types of processing that may be distributed across multiple resources (e.g., software units of execution, hardware units of execution, processors, microprocessors, clusters, labs) and may be performed at the same time.

For example, parallel programming may include task parallel programming where a number of tasks may be processed at the same time on a number of software units of execution. In task parallel programming, a task may be processed independently of other tasks executing, for example, at the same time.

Parallel programming may include data parallel programming, where data (e.g., a data set) may be parsed into a number of portions that may be executed in parallel using, for example, software units of execution. In data parallel programming, the software units of execution and/or the data portions may communicate with each other as processing progresses.

Parallel programming may include stream parallel programming (sometimes referred to as pipeline parallel programming). Stream parallel programming may use a number of software units of execution arranged, for example, in series (e.g., a line) where a first software Execution Unit may produce a first result that may be fed to a second software Execution Unit that may produce a second result given the first result. Stream parallel programming may also include a state where task allocation may be expressed in a directed acyclic graph (DAG) or a cyclic graph.

Other parallel programming techniques may involve some combination of task, data, and/or stream parallel programming techniques alone or with other types of processing techniques to form hybrid-parallel programming techniques.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of a electronic device, unless otherwise stated.

It is intended that the invention not be limited to the particular embodiments disclosed above, but that the invention will include any and all particular embodiments and equivalents falling within the scope of the following appended claims.

What is claimed is:

1. A geolocation messaging service method using a mobile device, the geolocation messaging service method comprising:
registering the mobile device of a first user and a device of a second user with an intermediate service;
determining location information of the mobile device of the first user;
transmitting the location information of the mobile device of the first user to the device of the second user via the intermediate service;
interpreting, by the intermediate service, the location information of the mobile device of the first user based on a mobile device type of the mobile device of the first user;
formatting the interpreted location information of the mobile device of the first user based on a device type of the device of the second user; and
transmitting the formatted location information of the mobile device of the first user to the device of the second user.

2. The geolocation messaging service method of claim 1, wherein the retrieving of the location information of the mobile device of the first user is based on the second user sending a location request message to the first user and the first user authorizing the transmission of the location information.

3. The geolocation messaging service method of claim 2, wherein the location request message comprises at least one of an identifier of the second user, the device type of the second user, and a phone number of the first user.

4. The geolocation messaging service method of claim 1, wherein the intermediate service authenticates the mobile device of the first user and the device of the second user and encrypts the formatted location information transmitted to the device of the second user.

5. The geolocation messaging service method of claim 1, wherein the location information of the mobile device of the first user comprises at least one of a geolocation of the first user, an identifier of the first user, an identifier of the second user, a message from the first user, and a keyword.

6. The geolocation messaging service method of claim 5, wherein the keyword is based on at least one of the geolocation of the first user, a location of a nearby service, a time of the day, and a previous location message.

7. The geolocation messaging service method of claim 1, wherein the retrieving location information of the mobile device comprises determining a geolocation of the mobile device of the first user based on a global positioning system receiver or a location based service.

8. The geolocation messaging service method of claim 1, the geolocation messaging service method further comprising:
selecting the second user from a database;
identifying the second user as a favorite;
storing the favorite in a favorites list; and
maintaining a history of locations and second users to which the location information has been transmitted.

9. A non-transitory electronic device readable storage medium storing instructions that, when executed by a processor, cause the processor to:
interact with a first hardware device,
the first hardware device determining location information of the first hardware device, and
the first hardware device transmitting location information of the first hardware device;
interact with a second hardware device,
the second hardware device receiving the location information of the first hardware device, and
the second hardware device displaying the location information of the first hardware device; and
interact with an intermediate server,
the intermediate server registering the first hardware device and the second hardware device,
the intermediate server interpreting the location information of the first hardware device based on a hardware type of the first hardware device,
the intermediate server formatting the interpreted location information based on a hardware type of the second hardware device, and
the intermediate server transmitting the formatted location information to the second hardware device.

10. The storage medium of claim 9, wherein the location information of the first hardware device is retrieved based on a second user sending a location request message to a first user and the first user authorizing the transmission of the location information of the first hardware device.

11. The storage medium of claim 10, wherein the location request message comprises at least one of an identifier of the second user, the device type of the second hardware device, and a phone number of the first user.

12. The storage medium of claim 9, wherein the intermediate server authenticates the first hardware device, authenticates the second hardware device, and encrypts the formatted location information of the first hardware device transmitted to the second hardware device.

13. The storage medium of claim 9, wherein the location information of the first hardware device comprises at least one of a geolocation of a first user, an identifier of the first user, an identifier of a second user, a message from the first user, and a keyword.

14. The storage medium of claim 13, wherein the keyword is based on at least one of the geolocation of the first user, a location of a nearby service, a time of the day, and a previous location message.

15. The storage medium of claim 9, wherein the location information of the first hardware device comprises a geolocation of the first hardware device determined using a global positioning system receiver or a location based service.

16. The storage medium of claim 9, storing instructions that, when executed by the processor, cause the processor to:
store the identity of a user in a database;
identify the user as a favorite;
store the favorite in a favorites list in the database, wherein a history of locations and a history of users to which the location information of the first hardware device has been transmitted is stored in the database.

17. A geolocation messaging system comprising:
a mobile device of a first user configured to determine and transmit location information of the mobile device;
a device of a second user configured to receive and display the location information of the mobile device of the first user; and
an intermediate server configured to:
register the mobile device of the first user and the device of the second user;
receive the location information of the mobile device of the first user;
interpret the location information of the mobile device of the first user based on a device type of the mobile device;
format the interpreted location information of the mobile device based on a device type of the device of the second user; and
transmit the formatted location information of the mobile device to the device of the second user.

18. The system of claim 17, wherein the location information of the mobile device of the first user is retrieved based on the second user sending a location request message to the first user and the first user authorizing the transmission of the location information.

19. The system of claim 17, wherein the intermediate server is further configured to authenticate the first user based on an identifier of the first user, authenticate the second user based on an identifier of the second user, and encrypt the location information of the mobile device of the first user transmitted to the device of the second user.

20. The system of claim 17, wherein the intermediate server is further configured to cross-reference the location information of the mobile device of the first user with a list of nearby advertisers and provide the list of nearby advertisers to the second user based on one or more keywords included in a message sent by the first user to the second user.
